(19) United States
(12) Patent Application Publication
(10) Pub. No.: US 2009/0285336 A1
(43) Pub. Date: Nov. 19, 2009

(54) Wideband Out-Of-Band-Receiver

(76) Inventors: Michael Anthony Pugel, Noblesville, IN (US); David Glen White, Indianapolis, IN (US)

Correspondence Address: Thomson Licensing LLC, P.O. Box 5312, Two Independence Way, PRINCETON, NJ, 08543-5312, US

(21) Appl. No.: 12/227,678

(22) PCT Filed: Jun. 16, 2006
(86) PCT No.: PCT/US2006/023490

§ 371 Date: Nov. 24, 2008

(51) Int. Cl. H04L 27/06

(52) U.S. Cl. 375/340

(57) ABSTRACT

The disclosed embodiments relate to a system that processes a received signal. An exemplary embodiment of the system comprises a receiver circuit that is adapted to receive the received signal and separate an out-of-band data signal corresponding to an out-of-band frequency spectrum from the received signal, an analog-to-digital (A/D) converter that converts the out-of-band data signal to a digitized out-of-band frequency spectrum signal, and a circuit that is adapted to identify data corresponding to an out-of-band data channel within the digitized out-of-band frequency spectrum signal.

### FIELD OF THE INVENTION

The present invention relates to improving the processing of out of band signals in communication systems, including out of band signals in cable television systems.

### BACKGROUND OF THE INVENTION

This section is intended to introduce the reader to various aspects of art which may be related to various aspects of the present invention which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Digital cable television systems are adapted to process signals that contain many channels of information. These channels may comprise various audio visual programs that may be tuned and viewed by a user of the system. Cable television signals may also include one or more out-of-band channels of information. The out-of-band channel may be used for a variety of purposes, such as to provide control information to a digital set top box that is receiving the cable signal. A program guide is another example of information that may be transmitted to a cable television receiver via an out-of-band communication channel. Out-of-band communication data may also be used to provide features such as allowing a user to select video on demand programs or the like.

Before the information in the out-of-band channel may be used, it must be separated from the received signal and decoded. Current systems employ complicated analog circuitry to identify the out-of-band channel in the received frequency spectrum. In current systems, the out-of-band channel may have a bandwidth of approximately one (1) MHz. The out-of-band signal may be placed somewhere in the overall transmitted frequency spectrum between 70 MHz and 130 MHz. The out-of-band signal may be referred to as a forward data channel.

The analog circuitry needed to locate and process the received out-of-band channel information adds cost and complexity to digital set top box receivers. A system and method that reduces complexity and cost of the circuitry associated with receiving and decoding out-of-band channel information is desirable.

### SUMMARY OF THE INVENTION

The disclosed embodiments relate to an exemplary system and method for processing a received signal. An exemplary embodiment of the system comprises a receiver circuit that is adapted to receive the received signal and separate an out-of-band data signal corresponding to an out-of-band frequency spectrum from the received signal, an analog-to-digital (A/D) converter that converts the out-of-band data signal to a digitized out-of-band frequency spectrum signal, and a circuit that is adapted to identify data corresponding to an out-of-band data channel within the digitized out-of-band frequency spectrum signal.

An exemplary method comprises the acts of separating an out-of-band data signal corresponding to an out-of-band frequency spectrum from a received signal, converting the out-of-band data signal to a digitized out-of-band frequency spectrum signal, and identifying data corresponding to an out-of-band data channel within the digitized out-of-band frequency spectrum signal.

### BRIEF DESCRIPTION OF THE DRAWINGS

In the drawings:

FIG. 1 is block diagram of a conventional out-of-band receiver;

FIG. 2 is a block diagram of an out-of-band signal receiver in accordance with an exemplary embodiment of the present invention;

FIG. 3 is a block diagram of a digital downconverter in accordance with an exemplary embodiment of the present invention;

FIG. 4 is a graph showing the conversion of an analog frequency spectrum that includes an out-of-band channel into the digital domain; and

FIG. 5 is a flow chart of a process in accordance with an exemplary embodiment of the present invention.

### DETAILED DESCRIPTION OF THE PREFERRED EMBODIMENT

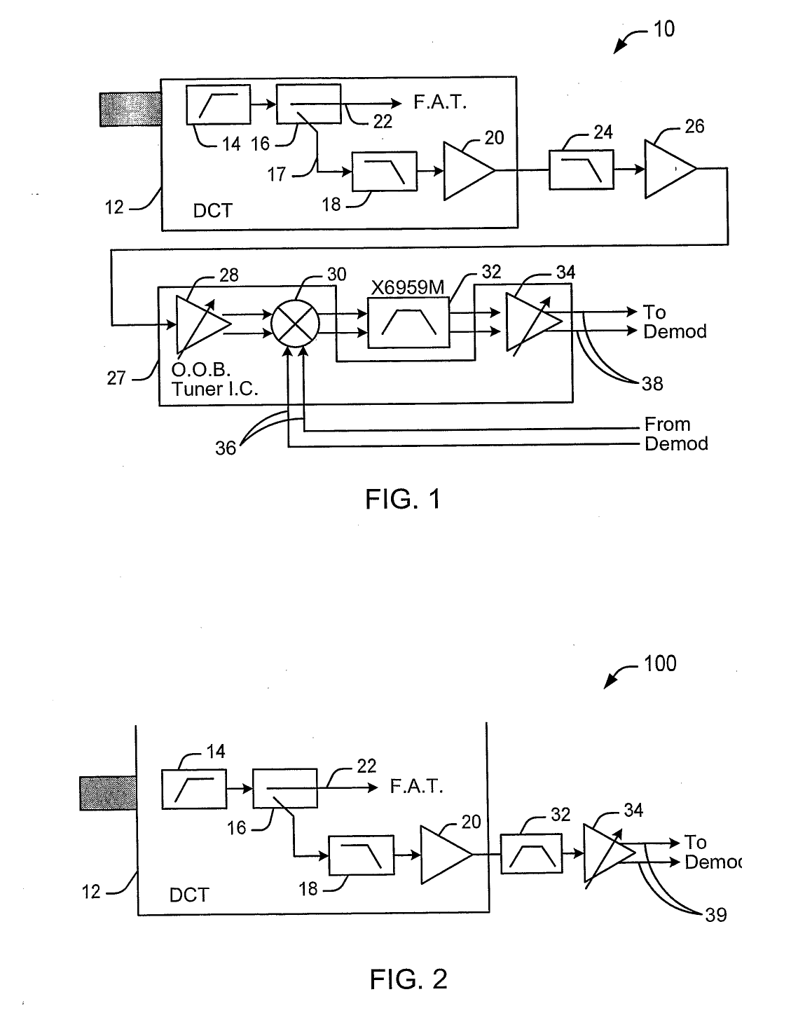

FIG. 1 is block diagram of a conventional out-of-band receiver 10. The out-of-band receiver 10 includes a digital cable tuner block 12, which is adapted to perform initial processing on a received cable television signal. The digital cable tuner block 12 comprises an input filter 14 which delivers a filtered input signal to a channel splitter circuit 16. The channel splitter circuit 16 divides the received input signal into a forward application transport (FAT) signal 22 and an out-of-band data signal 17. The FAT signal 22 contains information corresponding to various channels of audio visual programming. Further processing of the FAT signal is performed in a manner known to those of skill in the art.

The out-of-band data signal 17 is delivered by the channel splitting circuit 16 to a filter circuit 18. A filtered out-of-band data signal is delivered by the filter circuit 18 to an amplifier circuit 20. The out-of-band data signal is amplified by the amplifier circuit 20 and delivered to another filter 24 and another amplifier 26 prior to being processed by an out-of-band tuner block 27.

The out-of-band tuner block 27 comprises a variable gain amplifier 28 that amplifies the out-of-band data signal and delivers it to a mixer 30. The mixer 30 combines the out-of-band data signal with a feedback signal 36 from a demodulator block (not shown). The mixer 30 delivers the out-of-band data signal to a saw filter 32, which is adapted to filter out portions of the frequency spectrum except for that portion of the spectrum that contains the out-of-band data information. In U.S. cable systems, the portion of the frequency spectrum that contains an out-of-band data channel has a bandwidth of about 1 MHz. After processing by the saw filter 32, the out-of-band data signal may be processed by another variable gain amplifier 34 prior to being delivered as a processed out-of-band data signal 38 to a demodulator block (not shown).

As discussed above, the complexity of the out-of-band receiver 10 adds additional cost to digital cable TV receiving equipment such as set top boxes. Embodiments of the present invention relate to an improved system and method for receiving and decoding out-of-band data information.

FIG. 2 is a block diagram of an exemplary out-of-band signal receiver in accordance with an embodiment of the present invention. The out-of-band receiver 100 is adapted to provide a relatively small amount of analog filtering and gain prior to conversion of the entire 70 MHz to 130 MHz spectrum into the digital domain for further processing. The out-of-band receiver comprises a digital cable tuning block 12, as shown and described above with reference to FIG. 1.

After processing in the manner described above, however, the output of the digital cable tuner 12 is delivered directly to a saw filter 32, which is adapted to preserve information in the frequency spectrum that may contain an out-of-band data channel. This portion of the spectrum may be referred to herein as the out-of-band frequency spectrum. For example, the out-of-band frequency spectrum in U.S. cable systems ranges from about 70 MHz to about 130 MHz. Cable operators may arrange one or more out-of-band communication channels in this portion of the frequency spectrum.

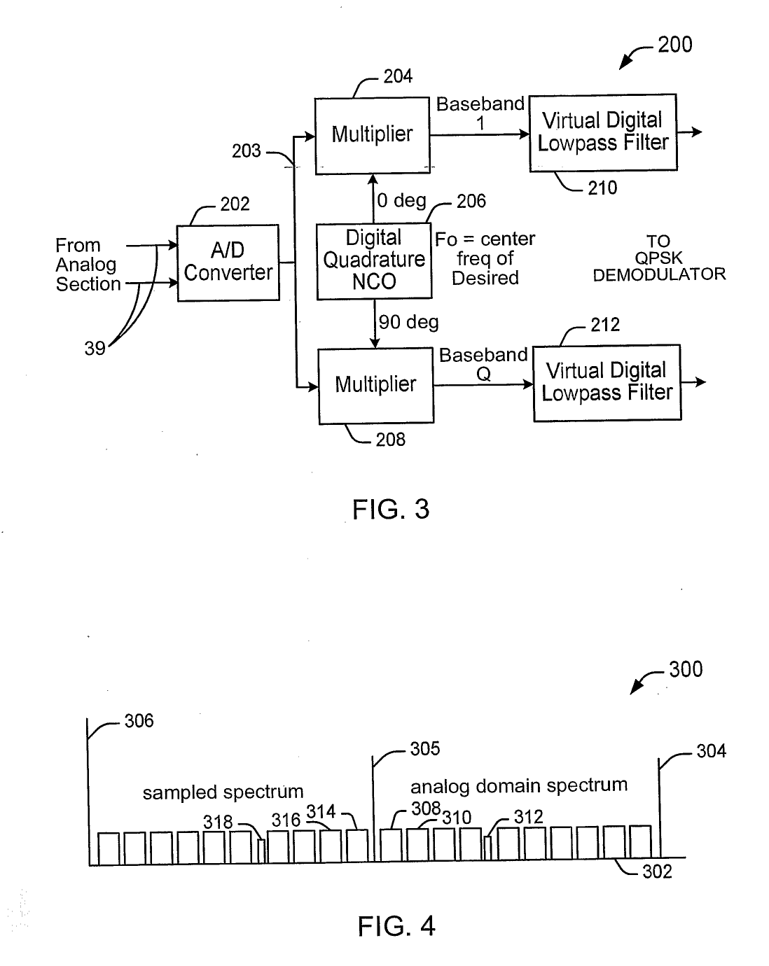

The output of the saw filter 32 is delivered to a variable gain amplifier 34. The variable gain amplifier 34 produces an out-of-band frequency spectrum output signal 39, which is an analog signal corresponding to a frequency range of about 70 MHz to about 130 MHz. Further processing of the analog out-of-band frequency spectrum output signal 39 is described with reference to FIG. 3.

Exemplary embodiments of the invention result in reduced out-of-band receiver circuit complexity and concomitantly reduced manufacturing cost. For example, the out-of-band receiver circuit 100 (FIG. 2), omits the filter 24 (FIG. 1), the amplifier 26 (FIG. 1), the variable gain amplifier 28 (FIG. 1) and the mixer 30 (FIG. 1) of the out-of-band receiver 10 (FIG. 1).

FIG. 3 is a block diagram of a digital downconverter 200 in accordance with an exemplary embodiment of the present invention. The digital downconverter 200 comprises an analog-digital (A/D) converter 202, which is adapted to receive the analog out-of-band frequency spectrum output signal 39 (FIG. 2). Thus, the A/D converter 202 is adapted to digitize the entire frequency spectrum in the range where the out-of-band data signal is expected.

It is desirable for the A/D converter 202 to have a resolution sufficient to digitize the entire frequency spectrum in the range where the out-of-band data signal may be located. More bits of resolution may be needed than the resolution needed to receive a typical quadrature phase shift keying (QPSK) signal, which is about 4 bits of resolution. The excess signal power delivered to the A/D converter 302 in terms of bits of range needed to digitize the 70 to 130 MHz frequency band (over and above the resolution needed to digitize a typical QPSK signal) corresponds to about 10 quadrature amplitude modulation (QAM) channels at an average power of +6 dB above the desired out-of-band channel. This power comprises about 6 bits. Accordingly, the A/D converter 202 may need a resolution on the order of about 10 bits to effectively decode the frequency spectrum between 70 and 130 MHz, in addition to a typical QPSK signal. Additional bits may be added to help ensure sufficient resolution to effectively digitize the relevant spectrum.

Embodiments of the present invention may employ a technique known as undersampling to create an image of the out-of-band data channel in the digital domain while operating at a lower sampling clock frequency than may otherwise may be expected. To process the spectrum between about 70 MHz and 130 MHz, an undersampling clock frequency in the range of about 130 MHz to 140 MHz may be employed. Those of ordinary skill in the art will appreciate, however, that the spectrum may be digitized without undersampling at a sampling clock frequency greater than about 260 MHz.

The A/D converter 202 delivers a digitized out-of-band frequency spectrum signal 203 to a first multiplier 204 and a second multiplier 208. The multipliers 204 and 208 receive input from a digital quadrature numerically controlled oscillator (NCO). The first multiplier 204 delivers a baseband I signal to a variable digital low pass filter 210. The second multiplier 208 delivers a baseband Q signal to a variable digital low pass filter 212. The outputs of the variable digital low pass filters 210 and 212 are delivered to a QPSK demodulator (not shown) for further processing. The digital quadrature NCO 206 acts to locate the digital information corresponding to the out-of-band data channel from within the digitized spectrum. For example, the digital quadrature NCO 206 may be adapted to sweep through the data represented by the analog out-of-band frequency spectrum output signal 39.

FIG. 4 is a graph showing the conversion of an analog frequency spectrum that includes an out-of-band channel into the digital domain by employing undersampling techniques. The graph is generally referred to by the reference number 300. An x-axis 302 corresponds to a frequency range. A y-axis 304 corresponds to a signal magnitude in the analog domain, which applies to the right-hand side of the graph 300. The y-axis 304 represents the sampling frequency Fs for the graph 300. A y-axis 305 divides the analog and digital domains in the graph 300. The y-axis 305 represents the Nyquist frequency (Fs/2) of the graph. A y-axis 306 corresponds to a signal magnitude in the digital domain, which applies to the left-hand side of the graph 300. The y-axis 306 represents the DC frequency of the graph 300.

The right-hand half of the graph 300 corresponds to an analog domain spectrum such as may be received by a digital cable tuner 12 (FIG. 2). The analog domain spectrum may comprise several FAT channels 308, 310. Additionally, the analog domain spectrum may contain an out-of-band data signal 312.

The left-hand portion of the graph 300 corresponds to the sampled analog frequency spectrum after it has been transformed into the digital domain by the A/D converter 202 (FIG. 3). The left-hand portion of the graph 300 shows an example of the digitizing of the analog out-of-band frequency spectrum output signal 39 (FIG. 3). The process of digitizing the analog out-of-band frequency spectrum output signal 39 has the effect of mirroring the frequency spectrum. In other words, the analog frequency spectrum represented by the right-hand side of the graph 302 is mirrored in the digital domain, as shown on the left-hand side of the graph 302. For example, the FAT channel 308 (analog domain) is represented in the digital domain by a mirror image FAT channel 314. The FAT channel 310 in the analog domain is represented in the digital domain by a mirror image FAT channel 316. Correspondingly, the out-of-band data signal 312 in the analog domain is represented in the sample digital domain by a mirror image out-of-band data signal 318.

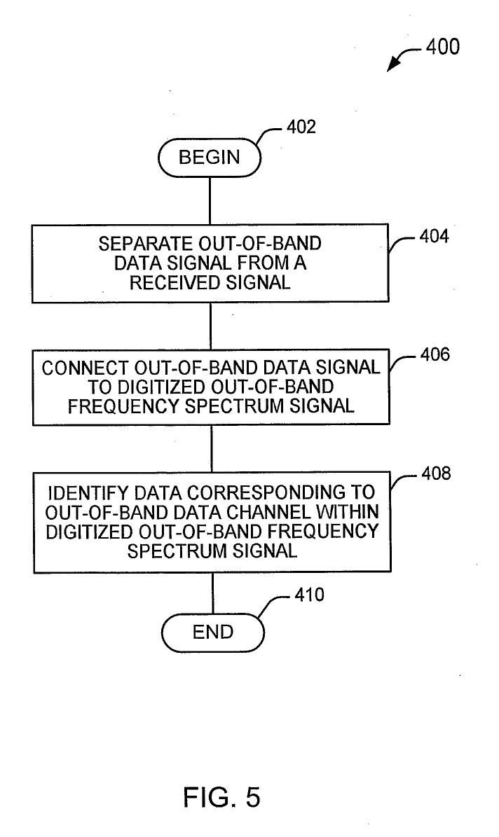

FIG. 5 is a flow chart of a process in accordance with an exemplary embodiment of the present invention. The process is generally referred to by the reference number 400. At block 402, the process begins.

At block 404, an out-of-band data signal is separated from a received signal. The out-of-band data signal may correspond to an out-of-band frequency spectrum. The out-of-band data signal is converted to a digitized out-of-band frequency spectrum signal at block 406. At block 408, data corresponding to the out-of-band data channel is identified within the digitized out-of-band frequency spectrum signal. The exemplary process ends at block 410.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

1. A signal processing system comprising:
a first circuit to receive a signal and separate an out-of-band data signal from the signal wherein said out-of band data signal corresponds to an out-of-band frequency spectrum from the signal;
an analog-to-digital (A/D) converter for converting the out-of-band data signal to a digitized out-of-band frequency spectrum signal; and
a second circuit to identify data corresponding to an out-of-band data channel within the digitized out-of-band frequency spectrum signal.

2. The signal processing system as recited in claim 1, wherein the out-of-band frequency spectrum ranges from about 70 MHz to about 130 MHz.

3. The signal processing system as recited in claim 1, wherein the first circuit comprises a saw filter

4. The signal processing system as recited in claim 1, wherein the second circuit is adapted to sweep through data corresponding to the digitized out-of-band frequency spectrum signal to identify the data corresponding to the out-of-band data channel.

5. The signal processing system as recited in claim 1, wherein the second circuit comprises a digital quadrature numerically controlled oscillator.

6. The signal processing system as recited in claim 1, wherein the out-of-band data channel has a bandwidth of about 1 MHz.

7. The signal processing system as recited in claim 1, wherein the A/D converter is adapted to undersample the out-of-band data signal

8. The signal processing system as recited in claim 1, wherein the A/D converter is adapted to undersample the out-of-band data signal at a sampling rate between about 130 MHz and about 140 MHz.

9. A method, comprising:
separating an out-of-band data signal corresponding to an out-of-band frequency spectrum from a signal;
converting the out-of-band data signal to a digitized out-of-band frequency spectrum signal; and
identifying data corresponding to an out-of-band data channel within the digitized out-of-band frequency spectrum signal.

10. The method as recited in claim 9, wherein the out-of-band frequency spectrum ranges from about 70 MHz to about 130 MHz.

11. The method as recited in claim 9, comprising filtering the out-of-band frequency spectrum from the signal.

12. The method as recited in claim 9, comprising sweeping through data corresponding to the digitized out-of-band frequency spectrum signal to identify the data corresponding to the out-of-band data channel.

13. The method as recited in claim 9, comprising processing the digitized out-of-band frequency spectrum signal with a digital quadrature numerically controlled oscillator.

14. The method as recited in claim 9, wherein the out-of-band data channel has a bandwidth of about 1 MHz.

15. The method as recited in claim 9, comprising undersampling the out-of-band data signal

16. The method as recited in claim 9,
comprising undersampling the out-of-band data signal at a sampling rate between about 130 MHz and about 140 MHz.

17. A system that processes a signal, the system comprising:
means for separating an out-of-band data signal corresponding to an out-of-band frequency spectrum from a signal;
means for converting the out-of-band data signal to a digitized out-of-band frequency spectrum signal; and
means for identifying data corresponding to an out-of-band data channel within the digitized out-of-band frequency spectrum signal

18. The system as recited in claim 17, wherein the out-of-band frequency spectrum ranges from about 70 MHz to about 130 MHz.

19. The system as recited in claim 17, wherein the means for converting is adapted to undersample the out-of-band data signal

20. The system as recited in claim 17, wherein the means for converting is adapted to undersample the out-of-band data signal at a sampling rate between about 130 MHz and about 140 MHz.
